(19) United States
(12) Patent Application Publication
(10) Pub. No.: US 2015/0211487 A1
(43) Pub. Date: Jul. 30, 2015

(54) DUAL PURPOSE SLAT-SPOILER FOR WIND TURBINE BLADE

(71) Applicant: Siemens Aktiengesellschaft, Munchen (DE)

(72) Inventors: Kristian R. Dixon, Boulder, CO (US); Edward A. Mayda, Thornton, CO (US)

(73) Assignee: Siemens Aktiengesellschaft, Munchen (DE)

(21) Appl. No.: 14/164,879

(22) Filed: Jan. 27, 2014

(51) Int. Cl. F03D 7/02

(52) U.S. Cl. CPC F03D 7/0232

(57) ABSTRACT

An aerodynamic slat (30) mounted over a forward suction side (40) of a wind turbine blade (22) and a mechanism (51A-F) that closes or reduces a gap (31) between slat and blade. The slat may pivot to reduce the gap, or the gap may be reduced by a device such as an extendable gate (58), or butterfly plate (59), or damper plate (60). Control logic (64) activates an actuator (70) of the mechanism to close or reduce the gap when wind conditions meet or exceed a predetermined criterion such as a rated wind condition. This reduces wind loading on the blade by separating airflow (53) over the suction side of the blade downstream of the slat. The blades can then maintain a higher angle of attack during rated wind conditions than in the prior art, allowing them to stall in gusts sooner to limit peak aerodynamic loads.

### FIELD OF THE INVENTION

This invention relates generally to the field of wind turbines, and more specifically to an apparatus for aerodynamic load reduction on wind turbines in high winds, and in particular to a dual purpose slat and spoiler for wind turbine blades.

### BACKGROUND OF THE INVENTION

Wind turbine blades have thick airfoil sections near the blade root to enable low-mass designs due to high structural efficiency. However, structural efficiency comes at the cost of decreased aerodynamic efficiency. Use of multi-element airfoils, which may include a slat and/or flap on the thick blade sections, generally improves aerodynamic performance while maintaining structural efficiency

Full-span blade pitch control effectively controls the aerodynamic rotor power by altering the angle of attack along the blade. When a wind turbine is operating at rated power output, the blades are pitched more towards feather (“into the wind”) which reduces the angle of attack and the resulting aerodynamic forces. However, this creates a large increase in lift generating potential during wind gusts (FIG. 10) which can quickly increase the angle of attack, leading to sharply increased aerodynamic forces and loads on the blades and other turbine components This imposes high structural strength margin requirements on all parts of the wind turbine installation, from the blades to the base of the tower, with resultant weight and expense.

### BRIEF DESCRIPTION OF THE DRAWINGS

The invention is explained in the following description in view of the drawings that show.

FIG. 1 is a suction side view of a prior art wind turbine rotor with slats.

FIG. 2 is a perspective view of an inboard portion of a prior art wind turbine blade with slats.

FIG. 3 is a transverse sectional view of a thick airfoil section with a slat taken along line 3-3 of FIG. 1.

FIG. 4 shows a slat/spoiler pivot embodiment according to aspects of the invention.

FIG. 5 shows another slat/spoiler pivot embodiment according to aspects of the invention

FIG. 6 shows a gate embodiment according to aspects of the invention.

FIG. 7 shows a butterfly plate embodiment according to aspects of the invention.

FIG. 8 shows damper embodiment according to aspects of the invention

FIG. 9 shows a control system embodiment for the invention

FIG. 10 is a graph of lift coefficient as a function of angle of attack as known in the art.

FIG. 11 shows a slat/spoiler pivot embodiment with actuators in the rotor hub

### DETAILED DESCRIPTION OF THE INVENTION

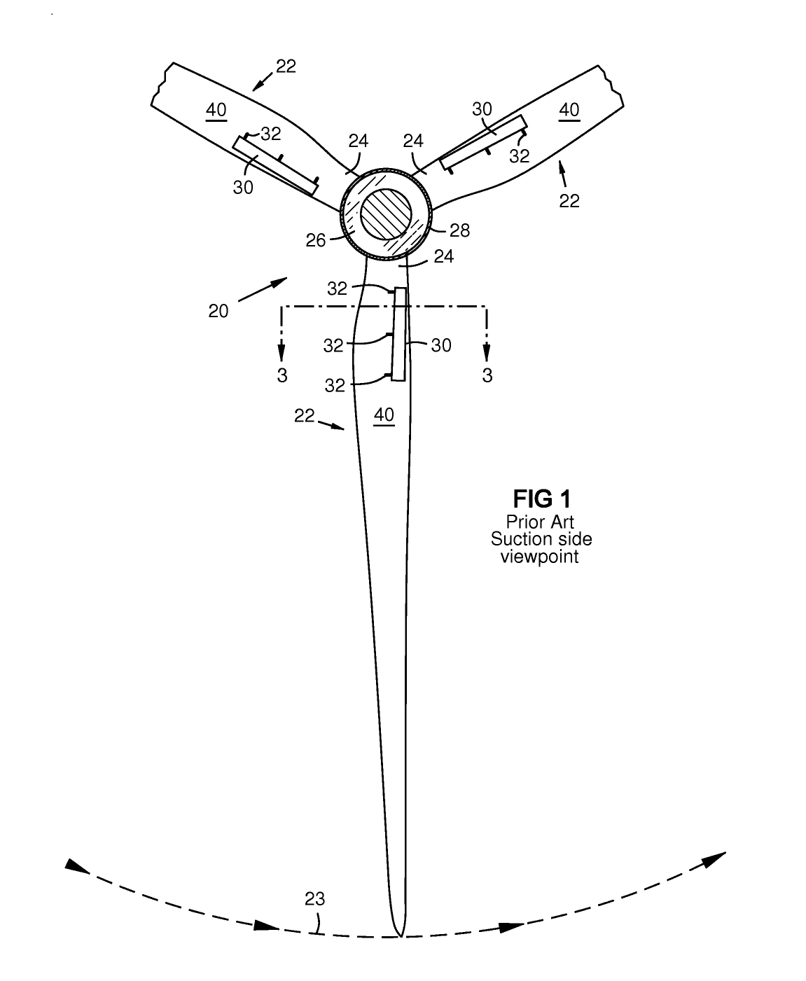

FIG. 1 shows a downwind side of a wind turbine rotor 20 with radially-oriented blades 22, sometimes referred to as main airfoils, which rotate generally in a plane 23 or disc of rotation The suction sides 40 of the blades are seen in this view, with the wind being directed generally through/into the plane of the page Only rotating elements are illustrated in this figure, with the typical nacelle and tower of a wind turbine power plant not being shown. Each main blade 22 has a radially inboard end or root end 24 that is thick to withstand flapwise loads that are normal to the chord of the blade airfoil. The roots 24 are attached to a common hub 26 that may have a cover called a spinner 28. Each blade may have an aerodynamic slat 30 mounted above a leading portion of each blade 22 by support structures such as aerodynamic struts 32. Slats provide increased aerodynamic efficiency and increased lift on the thick airfoil sections, both by acting as efficient small airfoils and by delaying and reducing flow separation on the suction side of the main airfoil

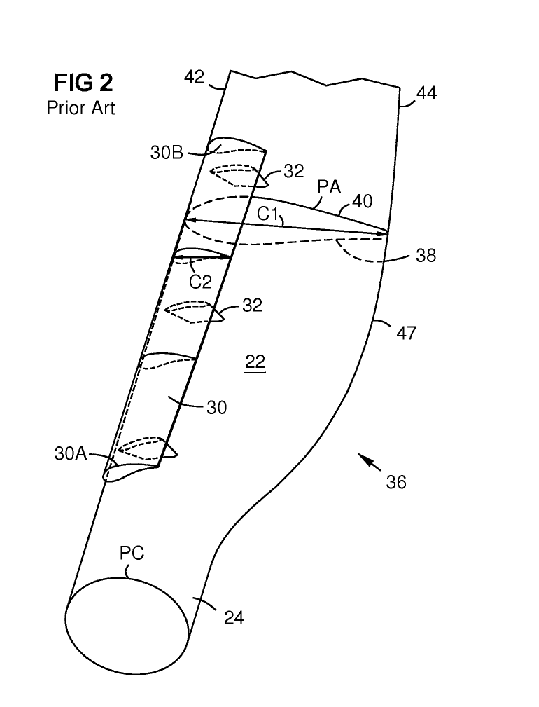

FIG. 2 is a perspective view of an inboard portion 36 of a blade 22 having a pressure side 38 and a suction side 40 between a leading edge 42 and a trailing edge 44 Transverse sectional profiles of the blade may gradually transition from cylindrical PC at the root 24 to an airfoil shape PA at and past the shoulder 47 which is the position of longest chord length of the blade 22. The slat 30 may have an efficient airfoil shape and angle of attack in normal operation throughout its span between its inboard end 30A and outboard end 30B. The main airfoil 22 and the slat 30 have respective chord lengths C1, C2.

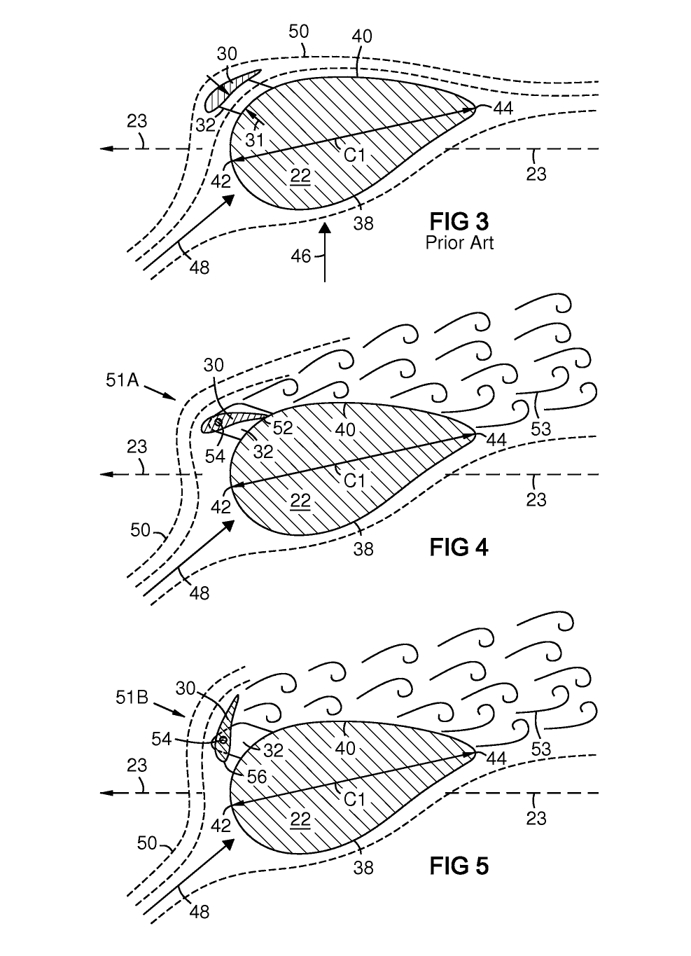

FIG. 3 shows a thick inboard airfoil section of a wind turbine blade 22 with a chord length C1 between leading and trailing edges 42, 44. A slat 30 is mounted with a given gap distance 31 above a leading suction side portion of the airfoil on aerodynamic struts 32. Also shown are a rotation plane 23, absolute wind direction 46, relative wind direction 48, and stream lines 50 influenced by the slat over the airfoil The slat helps prevent flow separation above the suction side 40.

FIG. 4 shows a slat/spoiler embodiment 51A according to aspects of the invention. The trailing edge 52 of the slat 30 pivots toward the main airfoil 22 via a pivot axis or bearing 54 actuated by means such as a servo motor, electromechanical solenoid, or hydraulic piston located for example in the blade, in a support strut 32, or in the rotor hub. In the shown pivoted position, the slat 30 stalls and partly or completely closes the gap between the slat and the main airfoil, causing the slat to act as a spoiler. This separates airflow 53 from the suction side 40 of the main airfoil, causing a loss of lift. Employing this effect during high operational wind speeds (after rated power has been achieved) reduces the amount of lift and power generated by the inboard blade sections equipped with spoiler slats To make-up for this reduced inboard power production the entire blade must then be pitched such that the outboard blade runs at a higher angle of attack, closer to stall, and therefore the potential for large aerodynamic load changes in the event of a gust for the entire blade (inboard and outboard) is reduced This effect can also be deployed during parked conditions or other non-operational states such that the spoiler limits the maximum possible lift that can be generated by the equipped sections in the event of extreme wind speeds. One benefit is that longer wind turbine blades are possible, allowing higher-efficiency wind turbines Another benefit is reduction in installation cost by reducing overall strength requirements and weight. Another benefit is reduced pitch activity and thus reduced wear on the pitch control system. Another benefit is reduction in pitch system cost, since it does not have to be as fast to react as quickly to gusts The axis of the pivot bearing 54 may be located at any position along the slat, such as at the aerodynamic center of the slat 30 in one embodiment to minimize actuation force, or at 25-50% of the slat chord length from the leading edge of the slat in other non-limiting embodiments

FIG. 5 shows a slat/spoiler embodiment 51B in which the leading edge 56 of the slat 30 pivots toward the main airfoil 22 in high winds. The minimum length of the gap between the slat 30 and the main airfoil 22 may be partly or completely closed by the pivot action The slat 30 pivots about a pivot bearing 54 on the support struts 32 under control of an actuator, such as a servo motor, electromechanical solenoid, hydraulic piston or other suitable means located in or on the blade 22, in a support strut 32, or in the rotor hub. Embodiments 51A and 51B may use the same or similar hardware, the difference being the direction of pivot, which may be determined based on wind conditions and the amount of aerodynamic braking wanted.

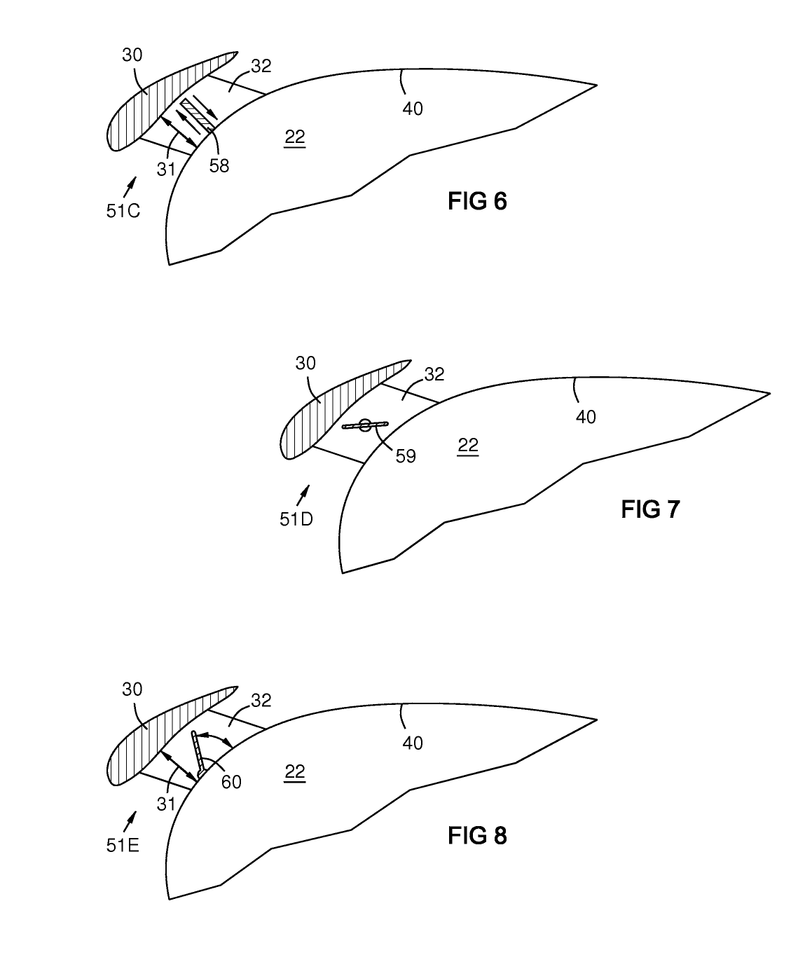

FIG. 6 shows a slat/spoiler embodiment 51C in which an extendable gate 58 forms a gate valve in the gap 31 that partially or completely or closes the gap between the slat 30 and the main airfoil 22. The gate 58 may be extended and retracted by an actuator in the main airfoil, such as a motor driven helical or pinion drive, electromechanical solenoid, or a hydraulic piston, as non-limiting examples.

FIG. 7 shows a slat/spoiler embodiment 51D in which a rotatable butterfly plate 59 partially or completely closes the gap between the slat 30 and the main airfoil 22. The butterfly plate may be rotated by an actuator in the strut 32, in the main airfoil 22, or in the rotor hub.

FIG. 8 shows a slat/spoiler embodiment 51E in which a damper plate 62 forms a valve that partially or completely closes the gap 31 between the slat 30 and the main airfoil 22 The damper plate 60 may be rotated by an actuator in the strut 32, or in the main airfoil, or in the rotor hub In embodiments 51C, 51D, and 51E, the slat 30 may be fixed and stationary with respect to the blade 22.

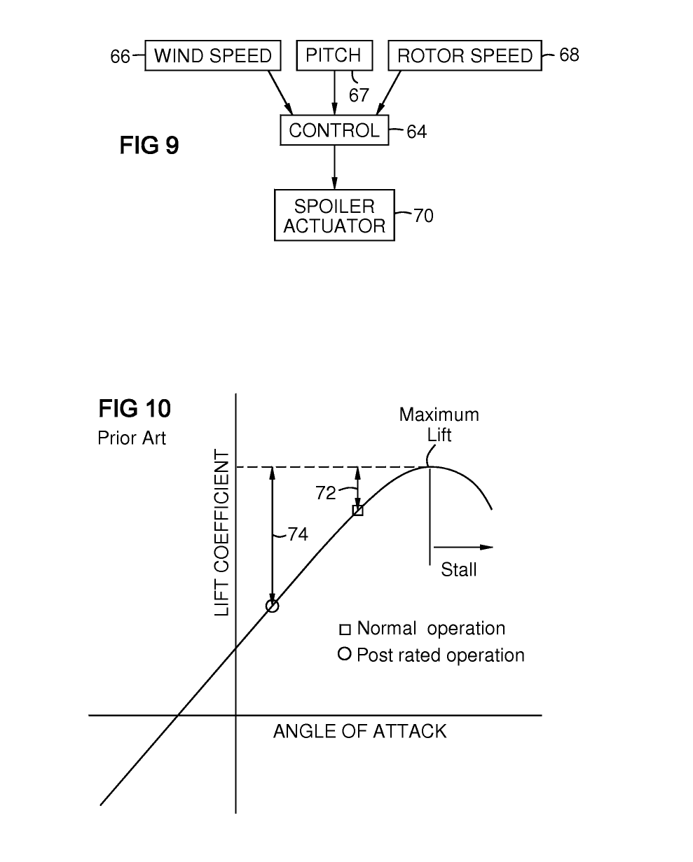

FIG. 9 shows a control logic unit 64 that uses available sensor inputs such as wind speed 66, pitch 67, and rotor speed 68 and/or derived parameters to activate the spoiler function of the embodiments herein via actuators 70 when one or more predetermined thresholds are reached For example, the spoiler function (i e reduction of the gap) may be activated when the wind reaches or exceeds a rated condition. This may be determined, for example, by wind speed and possibly other factors such as wind variability or aerodynamic loading on the rotor. Wind variability may be derived for example from instantaneous changes in wind speed or by derived metrics means such as statistical variance, or a combination of higher order wind speed derivatives.

FIG. 10 shows the lift coefficient on a wind turbine blade as a function of angle of attack Gusts can quickly increase both the wind speed and angle of attack During normal operation a gust causes a stall after a small increase in lift 72 During post-rated (high wind) operation the angle of attack is conventionally reduced to reduce lift. But this enables a greater increase in lift 74 caused by gusts before stall occurs, allowing high peaks in aerodynamic loading and subsequent structural stresses and fatigue. The invention allows the angle of attack to remain higher during post-rated operation, thus protecting the blade from overstress by enabling more rapid stall on the main airfoil during gusts than in the prior art.

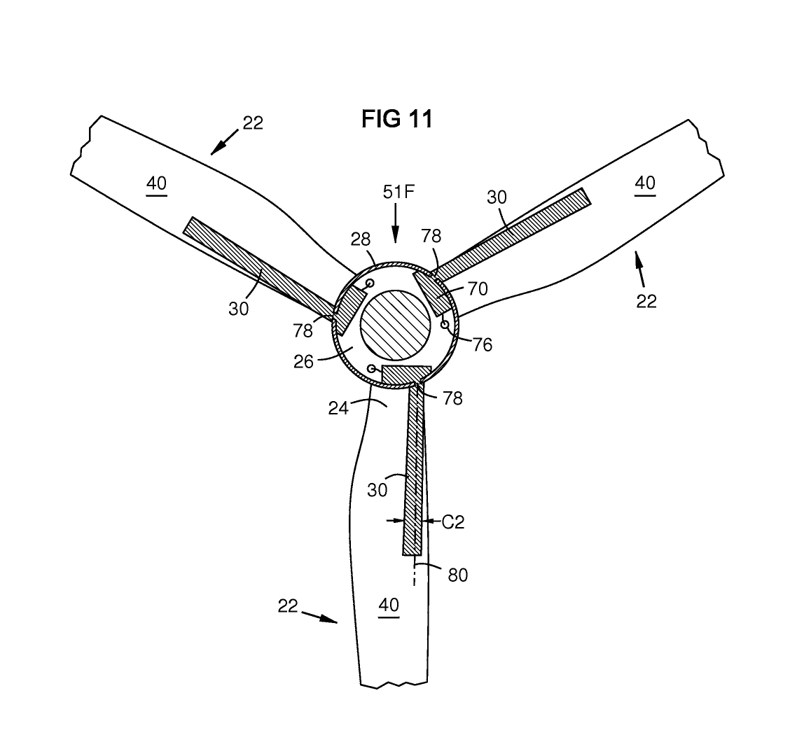

FIG. 11 shows an embodiment 51F in which each slat 30 extends from a respective pivot bearing 78 the rotor hub 26 Each slat pivots about a spanwise axis 80 positioned for example at 25-50% of the slat chord length C2 from the leading edge of the slat or positioned along an aerodynamic center of the slat. This embodiment may be implemented with cantilever slats without support struts Thus, it provides a relatively simple retrofit, for example, by installing a replacement spinner with attached slats 30, actuators 70, and power and logic connections 76.

The invention builds upon the use of multi-element airfoils by incorporating aerodynamic load control capabilities. These additional abilities reduce operational and non-operational aerodynamic blade loads and provide a mechanism for controlling rotor torque and power in addition to full-span pitch control The spoiler mechanisms of the embodiments herein have aerodynamic and structural synergy with the slat.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims

The invention claimed is:

1. A dual purpose slat-spoiler apparatus for a blade of a wind turbine, comprising:
an aerodynamic slat configured for mounting over a forward suction side of the blade, and
a mechanism configured to regulate a gap between the slat and the blade

2. The apparatus of claim 1, further comprising the slat being pivotally mounted on struts attached to the blade, the mechanism configured to pivot a trailing edge of the slat relative to the suction side of the blade.

3. The apparatus of claim 1, further comprising the slat being pivotally mounted on struts attached to the blade, the mechanism configured to pivot a leading edge of the slat relative to the suction side of the blade

4. The apparatus of claim 1, wherein the mechanism further comprises the slat being pivotally mounted on a bearing on a strut attached to the blade, the bearing comprising a pivot axis oriented spanwise along the slat, wherein the slat is actuated to pivot a leading edge or a trailing edge of the slat relative to the suction side of the blade.

5. The apparatus of claim 1, wherein the mechanism further comprises a gate operable to extend from and retract into the suction side of the blade within the gap.

6. The apparatus of claim 1, wherein the mechanism further comprises a rotatable butterfly plate positioned in the gap and forming a butterfly valve in the gap.

7. The apparatus of claim 1, wherein the mechanism further comprises a damper plate pivotally attached to the suction side of the blade within the gap

8. The apparatus of claim 1, wherein the mechanism further comprises an actuator and control logic that activates the actuator to close or reduce the gap during wind conditions meeting or exceeding a predetermined criterion.

9. A wind turbine comprising the apparatus of claim 1

10. A dual purpose slat-spoiler apparatus for a blade of a wind turbine, comprising.
a slat mounted over a suction side of a wind turbine blade,
a mechanism that regulates an airflow gap between the slat and the blade;
an actuator that operates the mechanism; and
control logic programmed to activate the actuator to close or reduce the gap when wind conditions meet or exceed a predetermined criterion.

11. The apparatus of claim 10, wherein the predetermined criterion comprises a rated wind condition of the wind turbine.

12. The apparatus of claim 10, wherein the mechanism further comprises the slat being pivotally mounted on a bearing on a strut attached to the blade, the bearing comprising a pivot axis oriented spanwise along the slat and positioned between 25-50% of a chord length of the slat from the leading edge of the slat, wherein the slat is actuated to pivot a leading edge or a trailing edge of the slat toward the suction side of the blade

13. The apparatus of claim 10, wherein the mechanism further comprises the slat being pivotally mounted via a bearing on a strut attached to the blade, the bearing comprising a pivot axis along an aerodynamic center of the slat, wherein the slat is actuated to pivot a leading edge or a trailing edge of the slat toward the suction side of the blade.

14. The apparatus of claim 10, wherein the mechanism further comprises a gate that extends from and retracts into the suction side of the blade within the gap

15. The apparatus of claim 10, wherein the mechanism further comprises a rotatable butterfly plate centrally positioned in the gap and forming a butterfly valve in the gap that closes or reduces the gap

16. The apparatus of claim 10, wherein the mechanism further comprises a damper plate pivotally attached to the suction side of the blade within the gap that pivots to close or reduce the gap

17. The apparatus of claim 10, wherein the slat is cantilevered over the blade from a slat pivot bearing in a hub of the wind turbine, and the mechanism further comprises an actuator in the hub that rotates the slat about a pivot axis oriented spanwise along the slat and positioned between 25-50% of a chord length of the slat from the leading edge of the slat, wherein the slat is actuated to pivot a leading edge or a trailing edge of the slat toward the suction side of the blade

18. The apparatus of claim 10, wherein the slat is fixed and stationary with respect to the blade

19. The slat-spoiler of claim 10, wherein the slat is attached to the blade by aerodynamic struts, and the slat remains and fixed and stationary with respect to the blade.

20. A wind turbine comprising the apparatus of claim 10.
